(19) United States
(12) Patent Application Publication
(10) Pub. No.: US 2008/0121733 A1
(43) Pub. Date: May 29, 2008

(54) Droplet generating device and method

(76) Inventors: Donald Ackley, Cardiff, CA (US); Anita Forster, Santee, CA (US)

Correspondence Address: ROBERT A. PARSONS, 4000 N. CENTRAL AVENUE, SUITE 1220, PHOENIX, AZ, 85012, US

(21) Appl. No.: 11/605,683

(22) Filed: Nov. 29, 2006

(51) Int. Cl. B05B 17/00

(52) U.S. Cl. 239/10

(57) ABSTRACT

A method of generating mono-dispersed nano- and micro-liposomes using droplet generators includes a step of providing a droplet generator with a carrier fluid inlet, a focusing fluid inlet, and an outlet for focusing fluid and liposomes. A carrier fluid including an aqueous solution and a focusing fluid including a solvent and lipid mixture are selected to form a partially miscible fluid system. The selected carrier fluid is injected into the carrier fluid inlet and the selected focusing fluid is injected into the focusing fluid inlet and the focusing fluid and liposomes are collected from the outlet. The focusing fluid is removed from the liposomes by diluting the focusing fluid in water.

This invention was made with U.S. Government support under contracts numbered NNJ05JB73C and NNJ06JA23C awarded by NASA Johnson Space Center. The U.S. Government has certain rights in the invention.

### FIELD OF THE INVENTION

This invention relates to microfluidic devices.

More particularly, the present invention relates to methods and apparatus for nano and micro droplet formation using droplet generators.

### BACKGROUND OF THE INVENTION

Formation of droplets using droplet generators, such as T-junctions and cross flow configurations, is known in the art. By employing immiscible fluids like oil and water, micro- and nano-droplets can be produced through shear and flow dynamics. This immiscible fluid system can produce monodisperse distributions of droplets and particles with sizes ranging from a few hundred nanometers to a few hundred microns. Nanoparticles such as liposomes are of particular interest in the field of drug delivery. This, however, requires that the nanoparticles (i.e. coated aqueous droplets) be carried in an aqueous solution. Unfortunately, a major limitation to the immiscible fluid system is the fact that the nano-droplets form an oil/water emulsion. In the case of nano- and micro-particle formation from the droplets, it is very difficult to separate out the target particles from the oil in the emulsion.

Engineered particles are typically a shell structure formed around a carrier fluid in the form of a nano- or micro-droplet. The shell structure can comprise materials such as polymers and the like, but in certain fields such as the medical field, lipid shells forming liposomes are desirable. Unfortunately, during droplet generation, aqueous droplets are typically formed with a single lipid layer shell.

Numerous techniques have been proposed for forming fully completed liposomes with bi-layer membranes. Ether vaporization was proposed by Deamer and Bangham (Biochemica et Biophysica Acta, 444, 629 (1976)) where ether containing lipids was injected into an aqueous solution at a rate slow enough that the vaporization of the ether occurred at the same rate as the injection rate, leaving only fully completed liposomes with lipid bi-layers. Ether, however, is an environmentally undesirable carrier fluid and the liposome characteristics are dependent on matching the injection and vaporization rates. It should be noted that Deamer et al. do not employ droplet generators.

Pautot et al. (Langmuir 19, 2870 (2003)) proposed a method in which single layer vesicles were formed in solvent, floated onto an aqueous solution with a lipid mono-layer on top, and then centrifuged through the lipid mono-layer to obtain fully completed liposomes in aqueous solutions. While this technique yields quality liposomes and could form asymmetric liposomes, it is highly dependent on the formation procedure and properties of the lipid mono-layer.

It would be highly advantageous, therefore, to remedy the foregoing and other deficiencies inherent in the prior art.

Accordingly, it is an object of the present invention to provide a new and improved method of generating nano- and micro-droplets using droplet generators.

Another object of the present invention is to provide a method for producing fully completed liposomes from a droplet-based single leaf vesicle.

### SUMMARY OF THE INVENTION

Briefly, to achieve the desired objects of the present invention in accordance with a preferred embodiment thereof, provided is a method of generating mono-dispersed nano- and micro-droplets using droplet generators. The method includes a step of providing a droplet generator with a carrier fluid inlet, a focusing fluid inlet, and an outlet for focusing fluid and droplets. A carrier fluid and a focusing fluid are selected to form a partially miscible fluid system and the selected carrier fluid and the selected focusing fluid are injected into the droplet generator to form droplets in the focusing fluid at the outlet.

The objects and other aspects of the invention are further achieved by a method of generating mono-dispersed nano- and micro-vesicles using droplet generators. The method includes a step of providing a droplet generator with a carrier fluid inlet, a focusing fluid inlet, and an outlet for focusing fluid and vesicles. A carrier fluid including an aqueous solution and a focusing fluid including a solvent and lipid mixture are selected to form a partially miscible fluid system. The selected carrier fluid is injected into the carrier fluid inlet and the selected focusing fluid is injected into the focusing fluid inlet and the focusing fluid and vesicles are collected from the outlet. The focusing fluid is removed from the vesicles by diluting the focusing fluid in water.

The objects and other aspects of the invention are further achieved by a method of generating fully completed liposomes using a droplet generator. The method includes a step of providing a droplet generator with a carrier fluid inlet, a focusing fluid inlet, and an outlet. An aqueous solution is selected for the carrier fluid and an immiscible or partially miscible focusing fluid is selected including a solvent and lipid mixture. The aqueous solution is injected into the carrier fluid inlet and the solvent and lipid mixture are injected into the focusing fluid inlet. The focusing fluid and vesicles of monolayer liposomes are removed through the outlet. The focusing fluid and vesicles are introduced into a container along with an aqueous buffer. The focusing fluid is less dense than the aqueous buffer so that the focusing fluid rises above the aqueous solution and lipids in the focusing solution add a second lipid layer to the single lipid layer of the vesicles to form fully completed liposomes in the aqueous buffer.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings; in which:

FIG. 1 is a schematic of one type of cross-flow droplet generator;

FIG. 2 is a simplified diagram of an initial procedure in a phase inversion technique;

FIG. 3 is a simplified diagram of a following procedure in the phase inversion technique;

FIG. 4 is a simplified diagram of a procedure in a layering technique; and

FIG. 5 is a simplified diagram of a procedure in an emulsion technique.

### DESCRIPTION OF THE PREFERRED EMBODIMENT

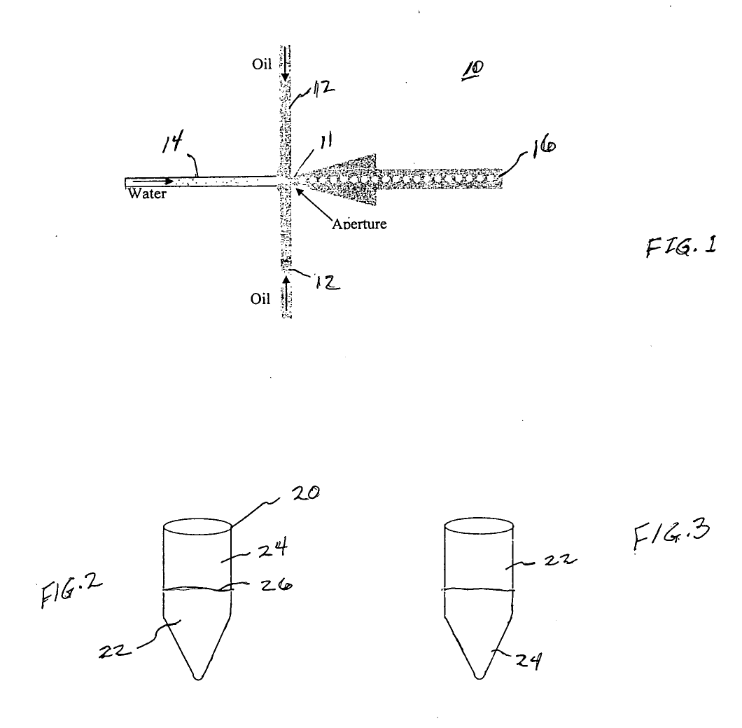

Turning now to the drawings in which like reference characters indicated corresponding elements throughout the several views, attention is first directed to FIG. 1 which illustrates a cross flow droplet generator generally designated 10. Nano- and micro-droplets are formed in generator 10 using immiscible fluids such as oil in cross channels 12 as focusing fluid and water in central channel 14 as a carrier fluid. The carrier fluid can carry various materials such as drugs, proteins, etc. for encapsulation. The combination of flow focusing from cross channels 12 and viscous shear forces results in the formation of droplets from the continuous flows of the two phases.

In the present method of forming nano- and micro-droplets and particles, partially miscible fluids are employed in the droplet generator system such as T-junction or cross flow configuration devices. Thus, a carrier fluid and a focusing fluid are used which form a partially miscible fluid system. Preferably, the partial miscibility of the fluid system is in a range of greater than zero to approximately 20%, depending upon the fluids employed. As partially miscible fluids, aqueous and preferably non-polar solvents are employed. The use of a partially miscible fluid system allows for the generation of mono-dispersed nano- and micro-droplets. The partially miscible fluid systems include preferably ionic liquids with melting points below 10 deg C.

Of particular interest are non-polar solvents which can dissolve lipids for the formation of liposomes in the droplet generators. Specific non-polar solvents include ether, cyclohexane, butanol, ethyl acetate, benzyl alcohol, and the like. Ethyl acetate is of particular interest for two reasons, first it is relatively nontoxic and second it is formed from ether and acetic acid and may be broken down into its constituents at relatively low concentrations. Overall, ethyl acetate was found to be about 8% miscible in water, which means that it can eventually be exchanged into a buffer solution. In addition, unlike other immiscible oil and water solutions, it has a high vapor pressure, and may be readily separated from water by evaporation. Based on the solubility of ethyl acetate and water, this system is sufficiently immiscible to form droplets in the droplet generators while being sufficiently miscible to mix with water. While an example of vesicle formation using lipids to form liposomes is described, it should be understood that vesicle formation using polymers to form polymer shells or combinations of lipids and polymers to form polysomes is included in the present method.

In a specific example, lipids are carried in a partially miscible solvent (ethyl acetate) and used as the focusing fluid in droplet generator 10, injected through channels 12. The carrier fluid (water) can carry various materials such as drugs, proteins, etc. and is injected through channel 14. The viscous shear forces between the focusing fluid and the carrier fluid generate droplets of the carrier fluid, coated with a mono-layer of lipids (liposomes). The liposomes with a single lipid layer are carried in the focusing fluid.

In an alternative example, the focusing fluid in droplet generator 10 is an aqueous solution containing lipids or polymers, and the carrier fluid is a partially miscible solvent carrying various materials that are poorly soluble in water, such as some protein-based drugs.

After liposome formation, the liposomes are flowed from an outlet 16 and the focusing fluid is removed by diluting the focusing fluid in water or aqueous buffer solution since the focusing fluid is partially miscible. One skilled in the art will understand that the dilution step can occur in a variety of aqueous solutions or washes that include water-based solutions with saline or small amounts of additives like alcohols, salts, ketones, etc. As an example, the focusing fluid with liposomes is directed into a large volume of water (50 to 100 times larger than the volume of the focusing fluid). The focusing fluid is then dissolved into the much greater volume of water significantly reducing the concentration of focusing fluid. By repeating the wash process several times, the focusing fluid concentration is reduced to negligible levels. This process is important for particles that cannot be dried for some structural or chemical reason.

As discussed above, vesicles are formed in a microfluidic, cross-junction droplet generator by flowing a carrier fluid down the central channel, and an immiscible or partially miscible focusing fluid containing shell-forming materials down the side channels. In this embodiment, the carrier fluid is aqueous and the focusing fluid is a solvent containing a lipid mixture. Due to the flow focusing and shear forces at the cross-junction, droplets are formed with the carrier fluid in the interior and a shell that forms from the shell-forming materials in the focusing fluid. In the case of liposomes, the shells form a single lipid layer, driven by hydrophobic forces to have their hydrophilic head groups pointed to the vesicle interior and their hydrophobic tails pointed to the exterior of the vesicle. This presents a problem in the formation of completed liposomes with lipid bi-layers as it is energetically favorable for the vesicles to remain in the solvent (focusing fluid) with a single layer membrane.

Referring to FIG. 2, a process, referred to herein as a phase inversion technique, of forming bi-layer liposomes includes providing a container 20. A first layer 22 of focusing fluid containing the single lipid layer of liposomes is collected in container 20. A second layer 24 of aqueous buffer is placed on first layer 22 with an interface 26 therebetween. First layer 22 of focusing fluid is less dense than second layer 24 of aqueous buffer and, as explained during the droplet formation process above, includes dissolved lipids. The amount of aqueous buffer is preferably about the order of the amount of the focusing fluid but is generally smaller than the amount of focusing fluid to concentrate the vesicles into the aqueous buffer.

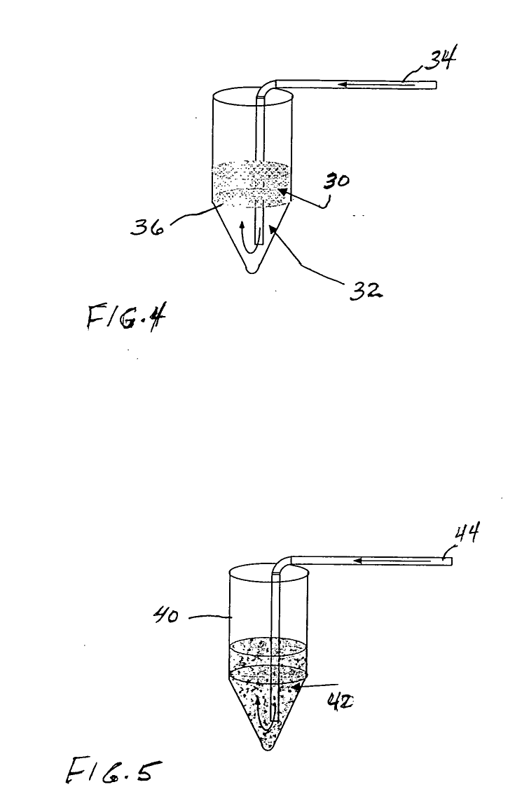

After the aqueous buffer is added to container 20, the solution rapidly inverts as illustrated in FIG. 3, with the more dense aqueous buffer moving to the bottom of container 20 and the less dense focusing fluid floating to the top. A key element to this process is that the vesicles, which are almost the same density as the aqueous buffer, do not flow to the top but are exchanged into the aqueous buffer. As there are excess lipids in the focusing fluid, in order for the vesicles to remain in the aqueous buffer it is energetically favorable for them to add a second lipid layer to the single lipid layer, thus protecting the hydrophobic tail groups and presenting hydrophilic head groups to the aqueous environment both inside and outside the now fully completed liposomes.

Alternatively, a solvent that is more dense than an aqueous buffer, such as benzyl alcohol, may be used for vesicle formation. In this case, the solvent containing vesicles is collected in a container, and then the collected solvent is added to a second container containing an aqueous solution. Since the solvent is denser than the aqueous buffer, inversion and liposome completion occurs, with the completed liposomes now residing in the upper aqueous solution in the second container.

An alternative method of piping the focusing fluid and vesicles to the bottom of a layer of aqueous buffer and allowing the less dense focusing fluid to float to the top can be performed. This alternative method has been found to be less effective than the preferred method described above. While other methods of moving the focusing fluid and vesicles through an aqueous buffer may be used, it is believed that the second lipid layer is added to form fully completed liposomes at or near the interface between the aqueous buffer and the focusing fluid. Thus, the inversion technique illustrated in FIGS. 2 and 3 is more efficient and a preferred method.

Alternatively, a solvent generally identical to the focusing fluid and containing excess lipids may be added to the container before the focusing fluid and vesicles are introduced, with the purpose of enhancing the completion of the liposomes. Excess lipids may preferentially be added to this solvent to further enhance the liposome completion process. If these lipids are different than the lipids comprising the vesicles, asymmetric liposomes may be formed during the completion process.

Another alternative method involves locating a layer of solvent 30 identical to the focusing fluid and containing additional lipids on top of a layer 32 of aqueous buffer as shown in FIG. 4. The focusing fluid and vesicles are delivered by a pipe 34 to the bottom of aqueous buffer layer 32 and the less dense focusing fluid and vesicles float to the top, encountering an interface 36 between aqueous buffer layer 32 and solvent 30. As there are a significant number of excess lipids supplied to that interface from the top solvent layer, the lipid bilayers are efficiently completed and segregate to the aqueous phase, leading to an enhanced yield of fully completed liposomes.

In a variation of the method disclosed in FIG. 4, the aqueous buffer layer 32 may contain additional lipids of desirable characteristics, which are supplied to the interface between solvent 30 and aqueous buffer 32 from below.

Yet another alternative method involves filling a container 40 with an emulsion 42 including an aqueous buffer and a solvent identical to the focusing fluid, further including excess lipids of a type desired to form the outer layer of the completed liposomes, as shown in FIG. 5. The focusing fluid and vesicles are delivered to the bottom of the emulsion layer 42 by a pipe 44, and float towards the top of the emulsion, encountering multiple interfaces between aqueous buffer and solvent. At each of these interfaces lipids are added to the outer layer of the vesicles, and eventually fully completed bilayers are formed. Over time, the emulsion will separate into solvent and aqueous phases, with the completed liposomes segregating to the aqueous phase. As there are a significant number of excess lipids supplied to the interfaces from the solvent, the lipid bilayers are again efficiently completed leading to an enhanced yield of fully completed liposomes. An advantage of using such an emulsion is that the solvent can be either more dense or less dense than the aqueous solution, with the only difference being that upon separation either the aqueous solution or the solvent will migrate to top of the container, depending on their relative densities.

By using a volatile solvent such as ethyl acetate for the focusing fluid, the focusing fluid which has risen to the top of container 20 may be evaporated off to leave a fully aqueous solution with a high concentration of fully completed liposomes. Alternatively, the excess focusing fluid may be pipetted or siphoned off to yield an aqueous solution containing completed liposomes. In the case where the focusing fluid is evaporated, remaining excess lipids end up floating to the top of the aqueous solution, adhering to the walls of container 20 as the focusing fluid evaporates. This effectively purifies the aqueous solution containing the completed liposomes. Even in the case where the focusing fluid is not volatile, the excess lipids will move to the solvent-water interface where they can be readily separated out.

By adding excess lipids of a second kind to the solvent before the addition of the aqueous buffer, asymmetric liposomes may be formed. If the second lipid is in sufficient excess, almost all of the liposomes will be completed in asymmetric form. This provides tremendous flexibility in producing liposomes with drug stabilizing inner layers and fully functionalized outer layers which can be optimized for in vivo delivery.

Alternatively, excess lipids of a second kind may be contained in excess in the aqueous buffer to form asymmetric liposomes.

Similarly, by adding excess lipids of the second kind to the top solvent layer, or to the solvent/aqueous buffer emulsion, asymmetric lipids may be formed.

It will be readily apparent to one skilled in the art that these methods for completing vesicles may be combined with methods known in the art for forming vesicles that do not utilize droplet generators.

Thus, a new and improved method of generating nano- and micro-droplets using droplet generators has been disclosed. The new method includes using a partially miscible fluid system. Also, a method for producing fully completed liposomes from a single leaf vesicle has been disclosed. In addition the novel method of producing fully completed liposomes allows the formation of complete liposomes in an asymmetric form.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. A method of generating mono-dispersed nano- and micro-droplets using droplet generators comprising the steps of:
providing a droplet generator with a carrier fluid inlet, a focusing fluid inlet, and an outlet for focusing fluid and droplets;
selecting a carrier fluid and a focusing fluid to form a partially miscible fluid system; and
injecting the selected carrier fluid into the carrier fluid inlet and the selected focusing fluid into the focusing fluid inlet.

2. A method as claimed in claim 1 wherein the partial miscibility of the fluid system is in a range of greater than zero to approximately 20%.

3. A method as claimed in claim 1 wherein the partially miscible fluid system includes aqueous solutions and non-polar solvents.

4. A method as claimed in claim 3 wherein the non-polar solvents include at least one of the following: ether, cyclohexane, butanol, benzyl alcohol, methyl acrylate, and ethyl acetate.

5. A method as claimed in claim 1 wherein the focusing fluid includes a non-polar solvent containing at least one of lipids and polymers.

6. A method as claimed in claim 1 wherein the focusing fluid includes an aqueous solution containing at least one of lipids and polymers.

7. A method as claimed in claim 1 including in addition the steps of flowing and collecting the focusing fluid from the outlet and removing the focusing fluid from the droplets by diluting the focusing fluid in an aqueous solution.

8. A method of generating mono-dispersed nano- and micro-vesicles using droplet generators comprising the steps of:
providing a droplet generator with a carrier fluid inlet, a focusing fluid inlet, and an outlet for focusing fluid and vesicles;
selecting a carrier fluid and a focusing fluid one of which includes a solvent to form a partially miscible fluid system, the partial miscibility of the fluid system being in a range of greater than zero to approximately 20%;
injecting the selected carrier fluid into the carrier fluid inlet and the selected focusing fluid into the focusing fluid inlet;
flowing and collecting the focusing fluid from the outlet with formed vesicles; and
removing the focusing fluid from the vesicles by diluting the focusing fluid in an aqueous solution.

9. A method of generating mono-dispersed nano- and micro-liposomes using droplet generators comprising the steps of:
providing a droplet generator with a carrier fluid inlet, a focusing fluid inlet, and an outlet for focusing fluid and liposomes;
selecting a carrier fluid including an aqueous solution and a focusing fluid including a solvent and lipid mixture to form a partially miscible fluid system;
injecting the selected carrier fluid into the carrier fluid inlet and the selected focusing fluid into the focusing fluid inlet;
flowing and collecting the focusing fluid and liposomes from the outlet; and
removing the focusing fluid from the liposomes by diluting the focusing fluid in an aqueous solution.

10. A method of generating fully completed liposomes comprising the steps of:
providing a fluid that is one of immiscible and partially miscible in water and forming a solution including the fluid and monolayer liposomes or single lipid layer vesicles in a container;
providing an aqueous buffer that is denser than the fluid;
introducing the aqueous buffer into the container on top of the solution so that the solution rises above the aqueous buffer and the monolayer liposomes or single lipid layer vesicles in the solution add a second lipid layer to the single lipid layer of the vesicles to form fully completed liposomes.

11. A method of generating fully completed liposomes using a droplet generator comprising the steps of:
providing a droplet generator with a carrier fluid inlet, a focusing fluid inlet, and an outlet for focusing fluid;
selecting an aqueous solution for the carrier fluid;
selecting a focusing fluid including a solvent and lipid mixture;
injecting the aqueous solution into the carrier fluid inlet and the solvent and lipid mixture into the focusing fluid inlet and removing focusing fluid and vesicles of monolayer liposomes through the outlet; and
introducing the focusing fluid and vesicles into a container with an aqueous buffer, the focusing fluid being less dense than the aqueous buffer so that the focusing fluid rises above the aqueous solution and lipids in the focusing solution add a second lipid layer to the single lipid layer of the vesicles to form fully completed liposomes.

12. A method as claimed in claim 11 wherein the step of introducing the focusing fluid and vesicles into the container includes forming a first layer of focusing fluid and vesicles at the bottom of the container, forming a second layer with the aqueous buffer on top of the first layer, and using an inversion technique to form fully completed liposomes in the aqueous buffer.

13. A method as claimed in claim 11 wherein the step of introducing the focusing fluid and vesicles into the container includes forming an emulsion of focusing fluid and aqueous solution which contains additional lipids in the bottom of the container, introducing the focusing fluid and vesicles into the emulsion, and forming fully completed liposomes in the aqueous buffer as it separates from the focusing fluid.

14. A method as claimed in claim 11 wherein the step of introducing the focusing fluid and vesicles into the container includes forming a layer of additional focusing fluid and excess lipids on top of the aqueous solution in the container, such that the excess lipids enable the formation of a greater number of fully completed liposomes.

15. A method as claimed in claim 11 including a step of evaporating the focusing fluid to leave an aqueous solution with a high concentration of fully completed liposomes.

16. A method as claimed in claim 11 including a step of one of pipetting and siphoning off the focusing fluid to leave an aqueous solution with a high concentration of fully completed liposomes.

17. A method as claimed in claim 11 wherein the step of selecting a focusing fluid including the solvent and lipid mixture includes lipids of a first kind and the method further includes a step of introducing excess lipids of a second kind to the focusing fluid in a container before the step of introducing the focusing fluid and vesicles into a container with an aqueous buffer, the fully completed liposomes being completed in one of symmetric form and asymmetric form.

18. A method as claimed in claim 17 wherein the excess lipids of the second kind are different than the lipids of the first kind and the fully completed liposomes are completed in an asymmetric form.

19. A method as claimed in claim 17 wherein the lipids of the second kind include one of polymers and combinations of lipids and polymers.

20. A method as claimed in claim 11 wherein the steps of selecting the aqueous solution and selecting the focusing fluid include selecting a carrier fluid and a focusing fluid to form a partially miscible fluid system.

21. A method as claimed in claim 20 wherein the partial miscibility of the fluid system is in a range of greater than zero to approximately 20%.

22. A method as claimed in claim 20 wherein the partially miscible fluid system includes aqueous and non-polar solvents.

23. A method as claimed in claim 20 wherein the partially miscible fluid system includes ionic liquids with a temperature in the range of 10-50 degrees C.

24. A method as claimed in claim 22 wherein the non-polar solvents include one of ether, cyclohexane, butanol, benzyl alcohol, and ethyl acetate.

25. A method as claimed in claim 20 wherein the focusing fluid includes a non-polar solvent containing lipids.

26. A method of generating fully completed liposomes using a droplet generator comprising the steps of:
providing a droplet generator with a carrier fluid inlet, a focusing fluid inlet, and an outlet for focusing fluid;
selecting an aqueous solution for the carrier fluid;
selecting a focusing fluid including a solvent and lipid mixture;
injecting the aqueous solution into the carrier fluid inlet and the solvent and lipid mixture into the focusing fluid inlet and removing focusing fluid and vesicles of monolayer liposomes through the outlet; and
introducing the focusing fluid and vesicles into a container with an aqueous buffer, the focusing fluid being more dense than the aqueous buffer so that the aqueous solution rises above the focusing fluid and lipids in the focusing solution add a second lipid layer to the single lipid layer of the vesicles to form fully completed liposomes.
